(19) United States
(12) Patent Application Publication
(10) Pub. No.: US 2020/0035137 A1
(43) Pub. Date: Jan. 30, 2020

(54) GOA CIRCUIT, AND DISPLAY PANEL AND DISPLAY APPARATUS INCLUDING THE SAME

(71) Applicant: SHENZHEN CHINA STAR OPTOLOCTRONICS TECHNOLOGY CO., LTD., Shenzhen, Guangdong (CN)

(72) Inventor: Shuai CHEN, Shenzhen (CN)

(73) Assignee: Shenzhen China Star Optoelectronics Technology Co., Ltd., Shenzhen, Guangdong (CN)

(21) Appl. No.: 16/322,072

(22) PCT Filed: Sep. 13, 2018
(86) PCT No.: PCT/CN2018/105493

§ 371 Date: Jan. 30, 2019

(30) Foreign Application Priority Data
Jul. 25, 2018 (CN) 201810828180.0

(51) Int. Cl. G09G 3/20

(52) U.S. Cl. CPC G09G 3/20; G09G 2310/08; G09G 2300/0408; G09G 2300/0426

(57) ABSTRACT

There is provided a GOA circuit, and a display panel and a display apparatus including the same. The GOA circuit includes: a pull-up control unit for pre-charging a first node; a pull-up unit for raising a potential of a scanning signal; a signal down-transmission unit for controlling ON and OFF of a next-stage signal; a pull-down unit for pulling potentials of the first node and the scanning signal down to a first voltage and maintaining the potential of the scanning signal at the first voltage; a pull-down maintaining unit for maintaining the potential of the first node at the first voltage; and a bootstrap unit for storing a voltage difference between the first node and a scanning signal output terminal.

### TECHNICAL FIELD

The present invention relates to a display technology field, and more particularly to a GOA circuit, a display panel and a display apparatus including the same.

### BACKGROUND ART

Traditional display displays images by using external driver chips to drive chips on display panels. In order to reduce the number of components and reduce manufacturing costs, in recent years, it has been gradually developed to directly manufacture a driving circuit structure on the display panel, such as a GOA technology. GOA (Gate Driver on Array) technology integrates gate driving circuits of a thin film transistor display on a glass substrate, to form a scan driving for the display panel. As compared with the traditional driving technology using COF (Chip on Flex/Film), the GOA technology can not only save cost significantly, but also omit a bonding process of COF at a gate side, and thus is also extremely advantageous to the enhancement of production capacity. Thus, the GOA technology is an important technology for development of the display panel.

FIG. 1 illustrates a schematic circuit diagram of a single-stage GOA circuit in prior art. As shown in FIG. 1, a single-stage GOA circuit 100 in prior art includes: a pull-up control unit 110 which is mainly used for pre-charging a first node Q(N); a pull-up unit 120 which is mainly used for raising a potential of a scanning signal output terminal G(N) and controlling turn-on of a transistor in a next-stage pull-down unit as will be described below; a signal down-transmission unit 130 which is mainly used for controlling transmission and turn-off of next-stage signals; a pull-down unit 140 which is mainly used for pulling potentials of the first node Q(N) and the scanning signal output terminal G(N) down to a potential of a first voltage input terminal VSS; a pull-down maintaining unit 150 which is mainly used for maintaining the potentials of the first node Q(N) and the scanning signal output terminal G(N) at the potential of the first voltage input terminal VSS; and a bootstrap unit 160 which is mainly used for raising and maintaining the potential of the first node Q(N).

Electronic components in the pull-down maintaining unit 150 shown in FIG. 1 are actually a Darlington structure inverter, and the specific circuit structure thereof is shown in FIG. 2. FIG. 2 illustrates a schematic circuit diagram of a Darlington structure inverter in prior art. The first voltage input terminal VSS inputs a low level signal, and a second voltage input terminal LC inputs a high level signal. When an input terminal Input of the inverter inputs a high level signal, an output terminal Output of the inverter outputs a low level signal. Otherwise, when the input terminal Input of the inverter inputs a low level signal, the output terminal Output of the inverter outputs a high level signal. On this basis, the structure of single-stage GOA circuit in prior art may also be that as shown in FIG. 3.

However, with the development of the GOA circuit, more and more functional structures are integrated in the circuit, thus the structure of the GOA circuit is becoming more and more complex, and the space occupied is also getting larger and larger. This is extremely disadvantageous to the design of narrow bezel display panel. Thus, how to improve the use efficiency of GOA function unit is an urgent problem to be solved in display panel industry.

### SUMMARY

To solve the above technical problem, the present invention is intended to provide a simplified GOA circuit and a display apparatus including the GOA circuit. A pull-down unit of the GOA circuit according to the present invention may perform better pull-down function with a lower potential, and meanwhile may also perform a function of the pull-down maintaining unit, thereby the structure of the GOA circuit may be simplified, and it also provides new ideas and thoughts for the narrow bezel design of display panel in the future.

According to an aspect of the present invention, there is provided a GOA circuit which is a cascaded multi-stage GOA circuit, wherein the Nth-stage GOA circuit may include: a pull-up control unit connected to a previous-stage scanning signal output terminal, a previous-stage stage-transmission signal output terminal and a first node, and pre-charging the first node through the previous-stage scanning signal under the control of the previous-stage stage-transmission signal; a pull-up unit connected to a first clock signal input terminal, the first node and a scanning signal output terminal, and raising a potential of a scanning signal through a first clock signal under the control of the first node; a signal down-transmission unit connected to the first clock signal input terminal, the first node and a stage-transmission signal output terminal, and outputting a stage-transmission signal through the first clock signal under the control of the first node to control ON and OFF of a next-stage signal; a pull-down unit connected to a next-stage scanning signal output terminal, a second clock signal input terminal, a first node, a scanning signal output terminal and a first voltage input terminal, for pulling the potentials of the first node and a scanning signal output terminal down to a first voltage under the control of a next-stage scanning signal and a second clock signal, and maintaining the potential of the scanning signal at the first voltage; a pull-down maintaining unit connected to a first voltage input terminal and the first node, and maintaining the potential of the first node at the first voltage; and a bootstrap unit coupled between the first node and the scanning signal output terminal, raising and maintaining the potential of the first node, wherein N is a natural number.

According to an exemplary embodiment of the present invention, the pull-up control unit may include a pull-up control transistor of which a gate is connected to the previous-stage stage-transmission signal output terminal, a source is connected to the previous-stage scanning signal output terminal, and a drain is connected to the first node.

According to an exemplary embodiment of the present invention, the pull-up unit may include a pull-up transistor of which a gate is connected to the first node, a source is connected to the first clock signal input terminal, and a drain is connected to the scanning signal output terminal.

According to an exemplary embodiment of the present invention, the signal down-transmission unit may include a signal down-transmission transistor of which a gate is connected to the first node, a source is connected to the first clock signal input terminal, and a drain is connected to the stage-transmission output terminal.

According to an exemplary embodiment of the present invention, the pull-down unit may include a first pull-down transistor of which a gate is connected to the second clock signal input terminal and a source and a drain are respectively connected to the scanning signal output terminal and the first voltage input terminal, and a second pull-down transistor of which a gate is connected to the next-stage scanning signal output terminal and a source and a drain are respectively connected to the first node and the first voltage input terminal.

According to an exemplary embodiment of the present invention, the pull-down maintaining unit may include an inverter unit and a pull-down maintaining transistor of which a gate is connected to an output terminal of the inverter unit, a source and a drain are respectively connected to the first node and the first voltage input terminal.

According to an exemplary embodiment of the present invention, the inverter unit may include first to fourth inverter transistors, wherein a source and a gate of the first inverter transistor are respectively connected to a second voltage input terminal and a drain of the first inverter transistor is connected to a source of the second inverter transistor and a gate of the third inverter transistor, a gate of the second inverter transistor is connected to the first node and a source and a drain of the second inverter transistor are respectively connected to the drain of the first inverter transistor and the first voltage input terminal, a gate of the third inverter transistor is connected to the drain of the first inverter transistor, a source of the third inverter transistor is connected to the second voltage input terminal, and a drain of the third inverter transistor is connected to a source of the fourth inverter transistor, and a gate of the fourth inverter transistor is connected to an input terminal of the inverter unit and a source and a drain of the fourth inverter transistor are respectively connected to the output terminal of the inverter unit and the first voltage input terminal.

According to an exemplary embodiment of the present invention, the first voltage input terminal may input a low level signal, and the second voltage input terminal may input a high level signal, wherein the first clock signal and the second clock signal are complementary signals.

According to an aspect of the present invention, there is provided a display panel including the above described GOA circuit.

According to an aspect of the present invention, there is provided a display apparatus including the above described display panel.

### BRIEF DESCRIPTION OF THE DRAWINGS

The drawings illustrate the exemplary embodiments of concept of the present invention and explain principle of the concept of the present invention together with the description, wherein the accompanying drawings are included to provide a further understanding to the concept of the present invention, and the drawings are included in and constitute a part of the description.

FIG. 1 is a schematic circuit diagram of a single-stage GOA circuit in prior art;

FIG. 2 is a schematic circuit diagram of a Darlington structure inverter in prior art;

FIG. 3 is a schematic circuit diagram of a single-stage GOA circuit in prior art;

FIG. 4 is a schematic circuit diagram of a single-stage GOA circuit according to an exemplary embodiment of the present invention; and

FIG. 5 is a timing diagram of a single-stage GOA circuit according to an exemplary embodiment of the present invention.

### DETAILED DESCRIPTION

In the following description, many specific details are elaborated for illustrative purposes, to provide thorough understanding for various exemplary embodiments. However, apparently, the various exemplary embodiments may be implemented without these specific details, or they can be implemented by means of one or more equivalent arrangements. In addition, like reference numbers refer to like elements.

Although terms of first, second and the like here can be used to describe various elements, components, areas, layers and/or parts, these elements, components, areas, layers and/or parts should not be limited by these terms. These terms are used for distinguishing an element, component, area, layer and/or portion part from another element, component, area, layer and/or part. Thus, a first element, a first component, a first area, a first layer and/or a first part discussed below may be named as a second element, a second component, a second area, a second layer and/or a second part without departing from the teaching of the present invention.

Unless otherwise defined, all the terms (including technological and scientific terms) used here have the same meaning as the meaning commonly understood by those ordinary in the art. Unless clear definitions were made here, terms (such as terms defined in a general dictionary) should be interpreted as having meanings consistent with their meanings in context of related fields, but should not be interpreted ideally and too formally.

In addition, the transistor in the present application may be a thin film transistor which includes a gate, a source and a drain. In the following embodiments, an N-type transistor is described as an example. However, the present invention is not limited thereto. In other embodiments, the transistor in the present application may also be a P-type transistor, and a timing diagram regarding signal will be amended accordingly when the transistor is the P-type transistor. Furthermore, the source and drain of the transistor in the present application may be exchanged.

Below, the exemplary embodiments of the present invention will be described by referring to the accompany drawings.

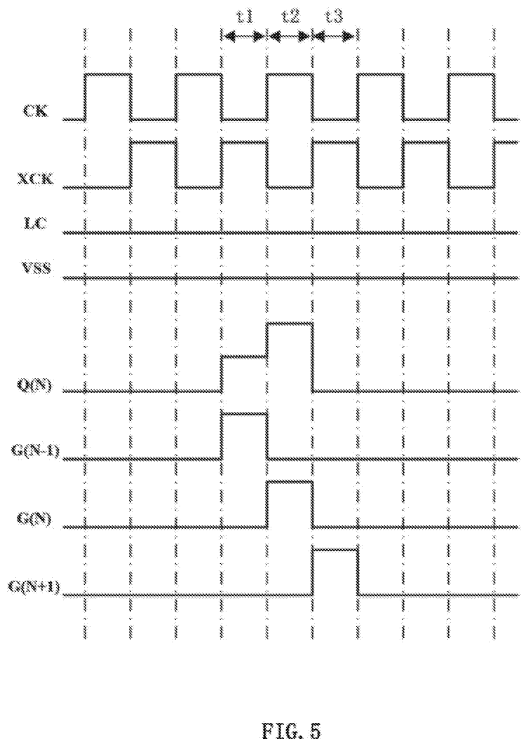

FIG. 4 is a schematic circuit diagram of a single-stage GOA circuit according to an exemplary embodiment of the present disclosure.

The GOA circuit according to the present invention may include a cascaded multi-stage GOA circuit. The Nth-stage GOA circuit is used as an example, wherein N is a natural number. Referring to FIG. 4, the single-stage GOA circuit according to an exemplary embodiment of the present invention may include a pull-up control unit 210, a pull-up unit 220, a signal down-transmission unit 230, a pull-down unit 240, a pull-down maintaining unit 250 and a bootstrap unit 260.

The pull-up control unit 210 may be connected to a previous-stage scanning signal output terminal G(N−1), a previous-stage stage-transmission signal output terminal ST(N−1) and a first node Q(N), and pre-charge the first node Q(N) through a previous-stage scanning signal under the control of a previous-stage stage-transmission signal. The pull-up control unit 210 may include a pull-up control transistor T11 of which a gate may be connected to a previous-stage stage-transmission signal output terminal ST(N−1), a source may be connected to a previous-stage scanning signal output terminal G(N−1), and a drain may be connected to the first node Q(N). Thus, the pull-up control transistor T11 may be turned on under the control of the previous-stage stage-transmission signal, to transmit the previous-stage scanning signal to the first node Q(N) in order to accomplish the pre-charging of the first node Q(N).

The pull-up unit 220 may be connected to a first clock signal input terminal CK/XCK, the first node Q(N) and a scanning signal output terminal G(N), and raise a potential of a scanning signal through a first clock signal under the control of the first node Q(N), to control ON of a next-stage second pull-down transistor as will be described below. The pull-up unit 220 may include a pull-up transistor T21. A gate of the pull-up transistor T21 may be connected to the first node Q(N), a source of the pull-up transistor T21 may be connected to the first clock signal input terminal CK/XCK, and a drain of the pull-up transistor T21 may be connected to the scanning signal output terminal G(N). Thus, the pull-up transistor T21 may be turned on under the control of the first node Q(N) and output the first clock signal to the scanning signal output terminal G(N), thereby raising the potential of the scanning signal.

The signal down-transmission unit 230 may be connected to the first clock signal input terminal CK/XCK, the first node Q(N) and a stage-transmission signal output terminal ST(N), and may output a stage-transmission signal through the first clock signal under the control of the first node Q(N) to control ON and OFF of a next-stage pull-up control transistor. The signal down-transmission unit 230 may include a signal down-transmission transistor T22. The gate of the signal down-transmission transistor T22 may be connected to the first node Q(N), the source of the signal down-transmission transistor T22 may be connected to the first clock signal input terminal CK/XCK, and the drain of the signal down-transmission transistor T22 may be connected to the stage-transmission signal output terminal ST(N). Thus, the signal down-transmission transistor T22 may be turned on under the control of the first node Q(N), to output the first clock signal as a stage-transmission signal.

The pull-down unit 240 may be connected to a next-stage scanning signal output terminal G(N+1), a second clock signal input terminal XCK/CK, the first node Q(N), the scanning signal output terminal G(N) and a first voltage input terminal VSS, and is used for pulling the potentials of the first node Q(N) and the scanning signal output terminal G(N) down to a first voltage under the control of a next-stage scanning signal and a second clock signal, and maintaining the voltage of the scanning signal at the first voltage. The pull-down unit 240 may include a first pull-down transistor T31 and a second pull-down transistor T41. A gate of the first pull-down transistor T31 may be connected to the second clock signal input terminal XCK/CK, a source and a drain of the first pull-down transistor T31 may be respectively connected to the scanning signal output terminal G(N) and the first voltage input terminal VSS. Thus, the first pull-down transistor T31 is turned on under the control of the second clock signal, and pulls the potential of the scanning signal down to the first voltage and maintains the scanning signal at the first voltage. A gate of the second pull-down transistor T41 may be connected to the next-stage scanning signal output terminal G(N+1), a source and a drain of the second pull-down transistor T41 may be respectively connected to the first node Q(N) and the first voltage input terminal VSS. Thus, the second pull-down transistor T41 is turned on under the control of the next-stage scanning signal and pulls the potential of the first node Q(N) down to the first voltage. The first voltage is at a low level, the second clock signal and the first clock signal are a pair of complementary signals.

The pull-down maintaining unit 250 may be connected to the first voltage input terminal VSS, the first node Q(N) and the second voltage input terminal LC, and is used for maintaining the potential of the first node Q(N) at the first voltage. The pull-down maintaining unit 250 may include an inverter unit 251 and a pull-down maintaining transistor T42. An input terminal of the inverter unit 251 is connected with the first node Q(N), and an output terminal of the inverter unit 251 is connected with the gate of the pull-down maintaining transistor T42 and converts the input high level signal into a low level signal to output to the gate of the pull-down maintaining transistor T42, and vice versa. A source and a drain of the pull-down maintaining transistor T42 may be respectively connected to the first node Q(N) and the first voltage input terminal VSS, and may be turned on under the control of an inverter output signal, to maintain the voltage of the first node Q(N) at the first voltage.

The inverter unit 251 may be a Darlington structure inverter which may include four transistors, i.e., first to fourth inverter transistors. A source and a gate of the first inverter transistor T51 may be connected to the second voltage input terminal LC, and a drain thereof may be connected to a source of the second inverter transistor T52 and a gate of the third inverter transistor T53. A gate of the second inverter transistor T52 is used as an input terminal of the inverter unit 251 and may be connected to the first node Q(N), and a source and a drain thereof may be respectively connected to the drain of the first inverter transistor T51 and the first voltage input terminal VSS. A gate of the third inverter transistor T53 may be connected to the drain of the first inverter transistor, a source thereof may be connected to the second voltage input terminal LC, and a drain thereof may be connected to a source of the fourth inverter transistor T54 and may serve as an output terminal of the inverter to connect with the gate of the pull-down maintaining transistor T42. A gate of the fourth inverter transistor T54 may be connected to the input terminal of the inverter unit 251, and the source and drain thereof may be respectively connected to the first voltage input terminal VSS and the first node Q(N). The second voltage input terminal LC may input the high level signal.

During the operation, when the input terminal of the inverter unit 251 inputs a low level signal, the second inverter transistor T52 and the fourth inverter transistor T54 are turned off, and the inverter unit 251 outputs a high level according to a second voltage; and when the input terminal of the inverter unit 251 inputs a high level signal, the second inverter transistor T52 and the fourth inverter transistor T54 are turned on, and thus the inverter unit 251 outputs a low level according to the first voltage.

The bootstrap unit 260 is coupled between the first node Q(N) and the scanning signal output terminal G(N) and may raise and maintain the potential of the first node Q(N). It may include a bootstrap capacitor Cbt. Both ends of the bootstrap capacitor Cbt are respectively connected to the first node Q(N) and the scanning signal output terminal G(N).

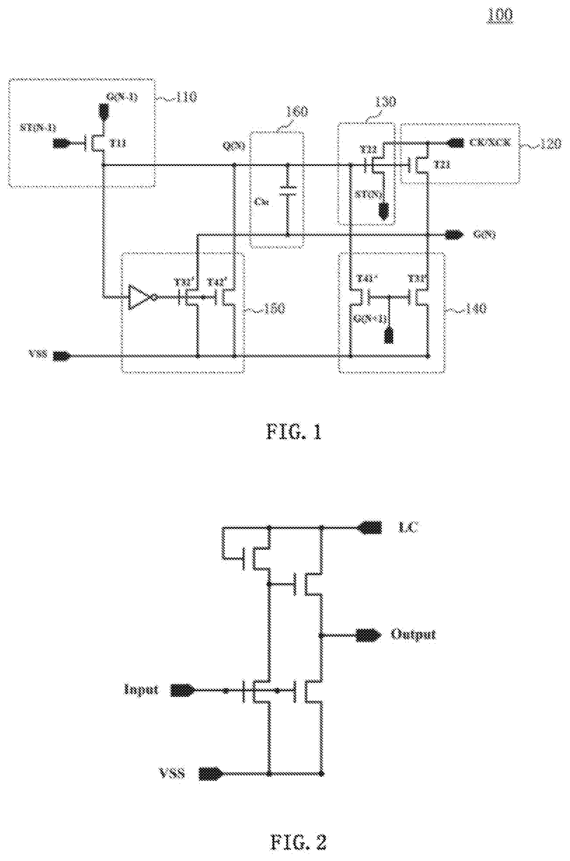

By comparing the single-stage GOA circuits shown in FIGS. 1, 3 and 4, it can be seen that the pull-down maintaining unit and the pull-down unit of the single-stage GOA circuit according to the exemplary embodiments of the present invention are different from those of the single-stage GOA circuit in prior art.

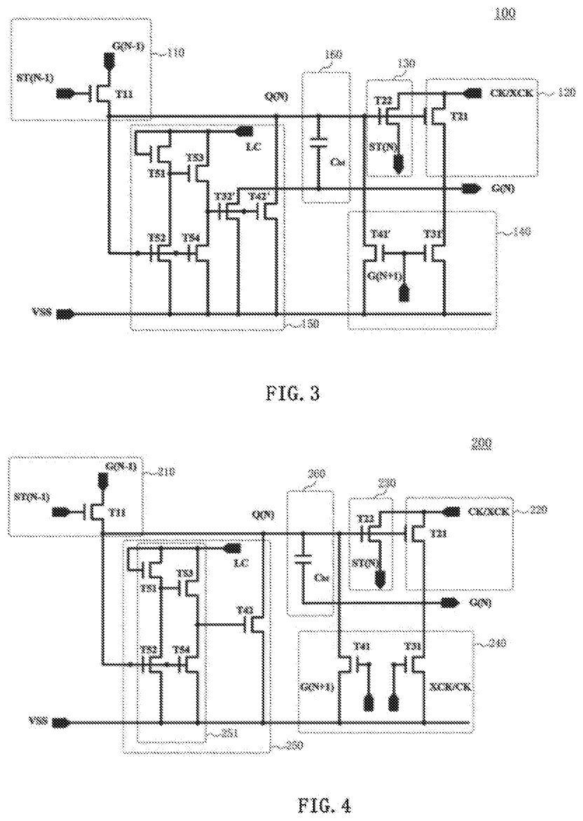

In the schematic circuit diagram shown in FIG. 3, the pull-down unit 140 includes two transistors T41′ and T31′, and gates of the transistors T31′ and T41′ are both connected to the next-stage scanning signal output terminal G(N+1), sources of the two are respectively connected to the first node Q(N) and the scanning signal output terminal G(N). Thus, the transistors T41′ and T31′ pull the potentials of the first node Q(N) and the scanning signal output terminal G(N) down to the first voltage under the control of the next-stage scanning signal output terminal G(N+1), respectively.

The pull-down maintaining unit 150 of the single-stage GOA circuit in prior art further includes two transistor T32′ and T42′ in addition to the inverter unit. Gates of the transistors T32′ and T42′ are respectively connected to the output terminal of the inverter unit, drains thereof are respectively connected to the first voltage input terminal VSS, and sources of the two are respectively connected to the scanning signal output terminal G(N) and the first node Q(N). Thus, the transistors T32′ and T42′ maintain the potentials of the scanning signal and the first node at the first voltage under the control of the output signal of the inverter unit 251, respectively.

By comparing the single-stage GOA circuits in prior art and the single-stage GOA circuit according to the exemplary embodiment of the present invention, the single-stage GOA circuit in prior art pulls down and maintains the potential of the scanning signal by the transistors T31′ and T32′, respectively, while in the GOA circuit according to the exemplary embodiment of the present invention, the transistor 32′ is cancelled, the first pull-down transistor T31 is controlled by the second clock signal XCK/CK for replacing the transistor T32′ and perform a function for pulling down and maintaining the potential of the scanning signal G(N) at the same time. Thus, the single-stage GOA circuit according to the exemplary embodiment of the present invention simplifies the circuit structure, and thus is advantageous to the narrow bezel design of display panel. Moreover, in the single-stage GOA circuit according to the exemplary embodiment of the present invention, the scanning signal G(N) may perform better pull-down function with a lower potential.

FIG. 5 shows a timing diagram of a single-stage GOA circuit according to an exemplary embodiment of the present perform. The first voltage input terminal VSS input a low level, and the second voltage input terminal LC input a high level. At time t1, a first clock signal input terminal CK inputs a clock signal of low level, a second clock signal input terminal XCK inputs a clock signal of high level, a previous-stage scanning signal output terminal G(N−1) inputs a scanning signal of high level, and a next-stage scanning signal output terminal G(N+1) inputs a scanning signal of low level. At this time, the previous-stage stage-transmission signal output terminal ST(N−1) inputs a stage-transmission signal of high level, the pull-up control transistor T11 is turned on, the high level of the previous-stage scanning signal is applied to the first node Q(N) through the turned on pull-up control transistor T11, and thus the first node Q(N) is at the high level. The pull-up transistor T21 may be turned on under the control of the high level of the first node Q(N), and the first clock signal is applied to the scanning signal output terminal G(N) through the pull-up transistor T21, and thus the scanning signal is at the low level. Meanwhile, the bootstrap capacitor Cbt stores a potential difference between the first node Q(N) and the scanning signal output terminal G(N). The input terminal of the inverter unit 251 is connected with the first node Q(N) and inputs the high level, thus the output terminal thereof outputs the low level. The pull-down maintaining transistor T42 connected with the inverter unit 251 is turned off. In addition, since the next-stage scanning signal output terminal G(N+1) outputs the low level, the second pull-down transistor T41 is also turned off, and thus the potential of the first node Q(N) will not be affected by the first voltage.

At time t2, the first clock signal input terminal CK inputs a high level, the second clock signal input terminal XCK inputs a low level, the previous-stage scanning signal output terminal G(N−1) inputs a low level, and the next-stage scanning signal output terminal G(N+1) keeps inputting the low level. At this time, the low level is input by the previous-stage stage-transmission signal output terminal ST (N−1) according to the previous-stage clock signal, the pull-up control transistor T11 is turned off, and thus the first node Q(N) is at the high level, the pull-up transistor T21 is turned on to output the high level corresponding to the first clock signal to the scanning signal output terminal G(N). A potential change of the scanning signal output terminal G(N) causes a voltage jump at an end of the bootstrap capacitor Cbt connected with the first node Q(N), thus, the potential of the first node Q(N) is further raised. Meanwhile, the pull-down maintaining transistor T42 and the second pull-down transistor T41 remain turn-off, and the potential of the first node Q(N) will not be affected by the first voltage. The first pull-down transistor T31 is also turned off under the control of the second clock signal, thus, the potential of the scanning signal output terminal G(N) will not be affected by the first voltage either.

At time t3, the first clock signal input terminal CK inputs a low level, the second clock signal input terminal XCK inputs a high level, the previous-stage scanning signal output terminal G(N−1) inputs a low level, and the next-stage scanning signal output terminal G(N+1) outputs a high level. At this time, a low level is input by the previous-stage stage-transmission signal output terminal ST (N−1), and the pull-up control transistor T11 is turned off. The pull-up transistor T21 and the signal down-transmission transistor T22 are turned off. The low level of the first node Q(N) is converted into a high level via the inverter unit 251, while the next-stage scanning signal output terminal G(N+1) and the second clock signal input terminal XCK both input high level, thus the first and second pull-down transistors and the pull-down maintaining transistor 42 are turned on, the voltage of the first node Q(N) is pulled down by the second pull-down transistor T41 and the pull-down maintaining transistor T42 and maintains at the first voltage. The voltage of the scanning signal is pulled down by the first pull-down transistor T31 and maintains at the first voltage VSS.

In addition, during a step change process of the second clock signal converting from a high potential to a low potential, there is a feedthrough function, according to an equation: ΔV=(V_{off}−Vₒₙ)·C_{gs}/Cₜₒₜₐₗ, wherein V^{off} and Vₒₙ are low potential and high potential of the second clock signal, C_{gs} is a parasitic capacitance of the first pull-down transistor T31, and Cₜₒₜₐₗ is a sum of the capacitances associated with the scanning signal. It can be seen from the equation that a certain degree of voltage drop exists in the scanning signal due to a feedthrough function, that is, the scanning signal will be pulled down to a lower potential and thereby play a better role in off-state.

According to an exemplary embodiment of the present invention, the present invention may provide a display panel which includes a display region and a GOA circuit located at an edge of the display region, wherein the GOA circuit has similar structure and principle as that in the above embodiments, which are omitted here.

According to an exemplary embodiment of the present invention, the present invention may also provide a display apparatus which may include the display panel in the above embodiments.

In conclusion, the present invention provides a simplified GOA circuit and a display panel and display apparatus including the GOA circuit. The pull-down unit of the GOA circuit according to the present invention may perform better pull-down function with a lower potential, and meanwhile may also perform a function of the pull-down maintaining unit, thereby the structure of the GOA circuit may be simplified, and it is advantageous to the narrow bezel design of display panel.

Although certain exemplary embodiments and implementations have already been described here, with this illustration, other embodiments and modifications will be apparent. Thus, the concept of the present invention is not limited to these embodiments, but limited by the proposed claims and various obvious modifications as well as a wider range of equivalents.

What is claimed is:

1. A GOA circuit, which is a cascaded multi-stage GOA circuit, wherein the Nth-stage GOA circuit comprises:
a pull-up control unit connected to a previous-stage scanning signal output terminal, a previous-stage stage-transmission signal output terminal and a first node, and pre-charging the first node through a previous-stage scanning signal under the control of a previous-stage stage-transmission signal;
a pull-up unit connected to a first clock signal input terminal, the first node and a scanning signal output terminal, and raising a potential of a scanning signal through a first clock signal under the control of the first node;
a signal down-transmission unit connected to the first clock signal input terminal, the first node and a stage-transmission signal output terminal, and outputting a stage-transmission signal through the first clock signal under the control of the first node to control ON and OFF of a next-stage signal;
a pull-down unit connected to a next-stage scanning signal output terminal, a second clock signal input terminal, the first node, the scanning signal output terminal and a first voltage input terminal, for pulling the potentials of the first node and the scanning signal output terminal down to a first voltage under the control of a next-stage scanning signal and a second clock signal, and maintaining the potential of the scanning signal at the first voltage;
a pull-down maintaining unit connected to a first voltage input terminal and the first node and maintaining the potential of the first node at the first voltage; and
a bootstrap unit coupled between the first node and the scanning signal output terminal, raising and maintaining the potential of the first node, wherein N is a natural number.

2. The GOA circuit of claim 1, wherein the pull-up control unit comprises a pull-up control transistor of which a gate is connected to the previous-stage stage-transmission signal output terminal, a source is connected to the previous-stage scanning signal output terminal, and a drain is connected to the first node.

3. The GOA circuit of claim 2, wherein the pull-up unit comprises a pull-up transistor of which a gate is connected to the first node, a source is connected to the first clock signal input terminal, and a drain is connected to the scanning signal output terminal.

4. The GOA circuit of claim 3, wherein the signal down-transmission unit comprises a signal down-transmission transistor of which a gate is connected to the first node, a source is connected to the first clock signal input terminal, and a drain is connected to the stage-transmission output terminal.

5. The GOA circuit of claim 4, wherein the pull-down unit comprises a first pull-down transistor and a second pull-down transistor,
wherein a gate of the first pull-down transistor is connected to a second clock signal input terminal, and a source and a drain of the first pull-down transistor are respectively connected to the scanning signal output terminal and the first voltage input terminal, and
wherein a gate of the second pull-down transistor is connected to the next-stage scanning signal output terminal, and a source and a drain of the second pull-down transistor are respectively connected to first node and the first voltage input terminal.

6. The GOA circuit of claim 5, wherein the pull-down maintaining unit comprises an inverter unit and a pull-down maintaining transistor of which a gate is connected to an output terminal of the inverter unit, a source and a drain are respectively connected to the first node and the first voltage input terminal.

7. The GOA circuit of claim 6, wherein the inverter unit comprises first to fourth inverter transistors,
wherein a source and a gate of the first inverter transistor are respectively connected to a second voltage input terminal, and a drain of the first inverter transistor is connected to a source of the second inverter transistor and a gate of the third inverter transistor,
a gate of the second inverter transistor is connected to the first node, and a source and a drain of the second inverter transistor are respectively connected to the drain of the first inverter transistor and the first voltage input terminal,
a gate of the third inverter transistor is connected to the drain of the first inverter transistor, a source of the third inverter transistor is connected to the second voltage input terminal, and a drain of the third inverter transistor is connected to a source of the fourth inverter transistor, and
a gate of the fourth inverter transistor is connected to an input terminal of the inverter unit, and a source and a drain of the fourth inverter transistor are respectively connected to the output terminal of the inverter unit and the first voltage input terminal.

8. The GOA circuit of claim 7, wherein the first voltage input terminal inputs a low level signal, the second voltage input terminal inputs a high level signal, and the first clock signal and the second clock signal are complementary signals.

9. A display panel including a GOA circuit, the GOA circuit being a cascaded multi-stage GOA circuit, wherein the Nth-stage GOA circuit comprises:
a pull-up control unit connected to a previous-stage scanning signal output terminal, a previous-stage stage-transmission signal output terminal and a first node, and pre-charging the first node through a previous-stage scanning signal under the control of a previous-stage stage-transmission signal;
a pull-up unit connected to a first clock signal input terminal, the first node and a scanning signal output terminal, and raising a potential of a scanning signal through a first clock signal under the control of the first node;
a signal down-transmission unit connected to the first clock signal input terminal, the first node and a stage-transmission signal output terminal, and outputting a stage-transmission signal through the first clock signal under the control of the first node to control ON and OFF of a next-stage signal;
a pull-down unit connected to a next-stage scanning signal output terminal, a second clock signal input terminal, the first node, the scanning signal output terminal and a first voltage input terminal, for pulling the potentials of the first node and the scanning signal output terminal down to a first voltage under the control of a next-stage scanning signal and a second clock signal, and maintaining the potential of the scanning signal at the first voltage;
a pull-down maintaining unit connected to a first voltage input terminal and the first node, and maintaining the potential of the first node at the first voltage; and
a bootstrap unit coupled between the first node and the scanning signal output terminal, raising and maintaining the potential of the first node, wherein N is a natural number.

10. The display panel of claim 9, wherein the pull-up control unit comprises a pull-up control transistor of which a gate is connected to the previous-stage stage-transmission signal output terminal, a source is connected to the previous-stage scanning signal output terminal, and a drain is connected to the first node.

11. The display panel of claim 10, wherein the pull-up unit comprises a pull-up transistor of which a gate is connected to the first node, a source is connected to the first clock signal input terminal, and a drain is connected to the scanning signal output terminal.

12. The display panel of claim 11, wherein the signal down-transmission unit comprises a signal down-transmission transistor of which a gate is connected to the first node, a source is connected to the first clock signal input terminal, and a drain is connected to the stage-transmission output terminal.

13. The display panel of claim 12, wherein the pull-down unit comprises a first pull-down transistor and a second pull-down transistor,
wherein a gate of the first pull-down transistor is connected to a second clock signal input terminal, and a source and a drain of the first pull-down transistor are respectively connected to the scanning signal output terminal and the first voltage input terminal, and
wherein a gate of the second pull-down transistor is connected to the next-stage scanning signal output terminal, and a source and a drain of the second pull-down transistor are respectively connected to first node and the first voltage input terminal.

14. The display panel of claim 13, wherein the pull-down maintaining unit comprises an inverter unit and a pull-down maintaining transistor of which a gate is connected to an output terminal of the inverter unit, a source and a drain are respectively connected to the first node and the first voltage input terminal.

15. The display panel of claim 14, wherein the inverter unit comprises first to fourth inverter transistors,
wherein a source and a gate of the first inverter transistor are respectively connected to a second voltage input terminal, and a drain of the first inverter transistor is connected to a source of the second inverter transistor and a gate of the third inverter transistor,
a gate of the second inverter transistor is connected to the first node, and a source and a drain of the second inverter transistor are respectively connected to the drain of the first inverter transistor and the first voltage input terminal,
a gate of the third inverter transistor is connected to the drain of the first inverter transistor, a source of the third inverter transistor is connected to the second voltage input terminal, and a drain of the third inverter transistor is connected to a source of a fourth inverter transistor, and
a gate of the fourth inverter transistor is connected to an input terminal of the inverter unit, and a source and a drain of the fourth inverter transistor are respectively connected to the output terminal of the inverter unit and the first voltage input terminal.

16. The display panel of claim 15, wherein the first voltage input terminal inputs a low level signal, the second voltage input terminal inputs a high level signal, and the first clock signal and the second clock signal are complementary signals.

17. A display apparatus including the display panel of claim 9.
